(19) United States
(12) Patent Application Publication
(10) Pub. No.: US 2004/0244294 A1
(43) Pub. Date: Dec. 9, 2004

(54) Drive

(76) Inventor: Stephan Schachtl, Munchen (DE)

Correspondence Address: Liniak, Berenato Longcare & White, 6550 Rock Spring Drive, Suite 240, Bethesda, MD, 20817, US

(21) Appl. No.: 10/492,290

(22) PCT Filed: Oct. 17, 2002
(86) PCT No.: PCT/EP02/11616

(30) Foreign Application Priority Data
Oct. 19, 2001 (DE) 101 52 696.2

(51) Int. Cl. E05F 11/24

(52) U.S. Cl. 49/339

(57) ABSTRACT

The invention relates to a drive (1) for pivoting a vehicle door or flap (3) which is connected to a hinge part (2) in a rotationally fixed manner. Said drive (1) comprises a motor (7) and a gear mechanism (9) which is arranged downstream form the same and acts on the hinge part (2) which is connected to a hinge axle (4) in a rotationally fixed manner. The aim of the invention is to provide one such drive (1) which is as compact as possible, the coupling between the drive (1) and the hinge part (2) being arranged in a simple manner and in such a way that it is as invisible as possible for a user. To this end, the gear mechanisms (9) of the drive (1) is directly connected to the hinge axis (4). A lever mechanism is preferable used as the gear mechanisms (9).

The invention relates to a drive for pivoting a vehicle door or vehicle flap (tailgate, engine hood etc.) which is connected in a rotationally fixed manner to a hinge strap.

German patent application 101 17 933.2 which has not been published before the date of the present application discloses a motor vehicle having an automatically closeable vehicle door or vehicle flap (also referred to below in summary just as vehicle door), in which the vehicle door can be closed or opened by means of a corresponding actuation of a switch provided in the instrument panel. For this purpose, the switching signal produced by the switch acts on an electronic control device, which for its part, produces electric control signals in order to activate an electric motor which then, for its part, acts on a lever-shaped extension of the hinge strap via a mechanism connected downstream and pivots or displaces the vehicle door.

One of the disadvantages of this motor vehicle is that the hinge strap has to be provided with an additional lever-shaped part. In addition, the drive is constructed in a manner such that it takes up a relatively large amount of space. Finally, that part of the drive which is connected to the hinge strap is frequently visible for a third party if the lever-shaped extension of the hinge strap is not situated for its entire pivoting distance for opening the tailgate etc. within the roof lining of the corresponding motor vehicle.

The invention is based on the object of specifying a drive of the type mentioned at the beginning which is constructed in a space-saving manner and in which the coupling between the drive and the hinge strap can be arranged in a simple manner and as far as possible invisibly for a third party.

This object is achieved according to the invention by the features of claim 1.

Further particularly advantageous refinements of the invention are disclosed in the subclaims.

The invention is based essentially on the concept of not connecting the drive to an additional, lever-shaped part of the hinge strap, but rather of acting directly on the hinge spindle, which is connected in a rotationally fixed manner to the hinge strap and is situated, for example, in the roof lining of the corresponding motor vehicle.

When the drive according to the invention is used, it is possible in an advantageous manner to fasten the corresponding hinges, including the hinge spindle with hinge strap, to the vehicle body, which has not yet been surface-treated, and to fit the drive, if desired, only at a later point into the otherwise finished vehicle. Since the drive according to the invention is conventionally connected to the hinge spindle laterally away from the hinge, the corresponding hinge spindle has, if appropriate, to be led or extended laterally out of the hinge.

In order to make a good transmission of force possible while requiring a relatively small amount of space, the use of a lever mechanism as the mechanism for pivoting the hinge spindle has proven advantageous in particular, a driving lever being connected in a rotationally fixed manner to the motor and a driven lever being connected in a rotationally fixed manner to the hinge spindle, and the two levers being connected to each other in an articulated manner via at least one coupling bar—preferably two coupling bars arranged symmetrically with respect to each other.

In order to compensate for tolerances associated with the coaxial nature between the drive shaft and the hinge spindle, it has proven expedient to fasten the coupling bars to the levers via pivoting bearings, so that wobbling movements of up to 5° around the main fastening point on the hinge spindle are possible.

Further details and advantages of the invention emerge from the following exemplary embodiments which are explained with reference to figures, in which:

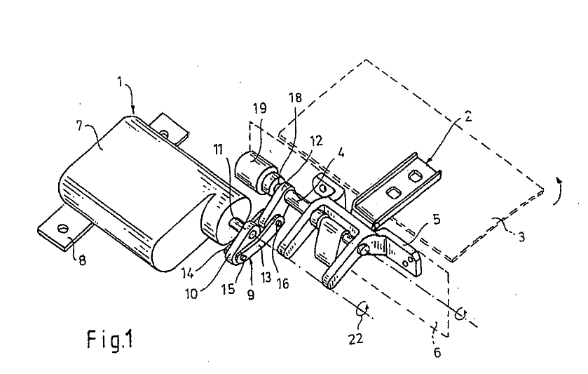

FIG. 1 shows the perspective illustration of a drive according to the invention with a lever mechanism without the mechanism housing, and

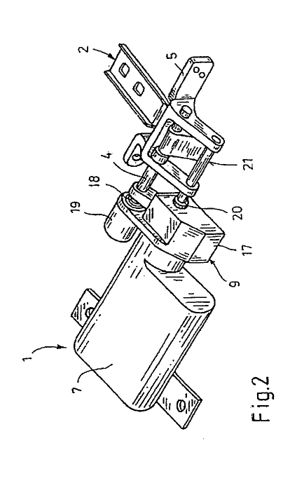

FIG. 2 shows an illustration corresponding to FIG. 1, in which the lever mechanism is provided with a mechanism housing.

In FIG. 1, 1 denotes a drive for pivoting a motor vehicle tailgate 3 (indicated by dashed lines) which is connected in a rotationally fixed manner to a hinge strap 2. The hinge strap 2 is connected in a rotationally fixed manners to a hinge spindle 4 which is arranged pivotably on a hinge 5. The hinge 5 is fastened to the body 6 (likewise indicated by dashed lines) of the corresponding vehicle.

The drive 1 comprises an electric motor 7, which is likewise fastened to the body of the vehicle via a flange 8, and a lever mechanism 9, which is connected to the electric motor 7. The lever mechanism 9 has a driving lever 10 which is connected in a rotationally fixed manner to the driven shaft 11 of the electric motor 7 (or of an intermediate mechanism in the event of a geared motor). In addition, the lever mechanism 9 comprises a driven lever 12 which is connected in a rotationally fixed manner via a form-fitting connection (e.g. splined toothing) to the hinge spindle 4, which protrudes laterally over the hinge 5. The driving lever 10 and the driven lever 12 of the lever mechanism 9 are connected to each other in an articulated manner via two coupling bars 13, 14. In this case, the coupling bars 13, 14 are fastened to the levers 10, 12 via pivoting bearings 15, 16 in order to compensate for tolerances between the driven shaft 11 of the electric motor 7 and the hinge spindle 4.

During the use of the drive 1 as intended, the lever mechanism 9 is covered by a housing 17 (FIG. 2) on which a pivoting bearing 18, in which the hinge spindle 4 is mounted pivotably, is arranged, so that the drive 1 is centered with respect to the hinge spindle 4. An angle transmitter 19, which is likewise fastened to the housing 17, is connected in rotationally fixed manner to the hinge spindle 4 and serves for determining the position of the tailgate 3, is situated behind the pivoting bearing 18.

Furthermore, a mount 20 for a rod-shaped supporting element 21, which is fastened to the hinge 5 and is used for the angular support of the drive 1, is provided on the housing 17 of the lever mechanism 9.

If the tailgate 3 is to be pivoted upward, for example from the position illustrated in FIG. 1, then the electric motor 7 is activated via a corresponding switching device (not illustrated). The driven shaft 11 of the electric motor 7 then rotates counterclockwise in the direction of the arrow denoted by 22. The driving lever 10 is pivoted downwards and carries along the driven lever 12 via the coupling bars 13, 14. Said driven lever then also rotates the hinge spindle 4 counterclockwise. The tailgate opens as far as a predetermined position, in which the angle transmitter 19 switches off the electric motor 7 directly or via the switching device (not illustrated).

Of course, the invention is not restricted to the above-described exemplary embodiment. Thus, the mechanism does not absolutely have to be a lever or crank mechanism, but rather it is also possible, for example, for a gear wheel mechanism to be used.

Furthermore, instead of pivoting bearings, use may also be made, for example, of needle bearings for fastening the coupling bars 13, 14 to the levers 10, 12 if only relatively small tolerances between the driven shaft 11 and the hinge axis 4 have to be taken into consideration.

The motor may also be a hydraulically or pneumatically driven motor.

Finally, the housing 17 may also be part of a housing comprising the entire drive 1.

### List of Reference Numbers

1 Drive

2 Hinge strap

3 Tailgate, vehicle flap

4 Hinge spindle

5 Hinge

6 Body

7 Electric motor, motor

8 Flange

9 Lever mechanism, mechanism

10 Driving lever, lever

11 Driven shaft

12 Driven lever

13, 14 Coupling bars

15, 16 Pivoting bearings

17 Housing

18 Pivoting bearing

19 Angle transmitter

20 Mount

21 Supporting element

22 Arrow

1. A drive for pivoting a vehicle door or vehicle flap (3) which is connected in a rotationally fixed manner to a hinge strap (2), having the following features:
a) the drive (1) comprises a motor (7) and a mechanism (9) which is connected downstream of the motor (7) and acts on the hinge strap (2) which is connected in a rotationally fixed manner to a hinge spindle (4);
b) the mechanism (9) is connected in a rotationally fixed manner on the driven side to the hinge spindle (4).

2. The drive as claimed in claim 1, characterized in that the mechanism (9) is a lever mechanism, a driving lever (10) being connected in a rotationally fixed manner to the motor (7) and a driven lever (12) being connected in a rotationally fixed manner to the hinge spindle (4), and two levers (10, 12) being connected to each other in an articulated manner via at least one coupling bar (13, 14).

3. The drive as claimed in claim 2, characterized in that the driving lever (10) and the driven lever (12) are connected to each other in an articulated manner by means of two coupling bars (13, 14) arranged symmetrically with respect to each other on both sides of the levers (10, 12).

4. The drive as claimed in claim 2, characterized in that the coupling bars (13, 14) are fastened to the driving lever (10) and to the driven lever (12) via pivoting bearings (15, 16).

5. The drive as claimed in claim 1, characterized in that the driven lever (12) can be connected in a form-fitting manner to the hinge spindle (4).

6. The drive as claimed in claim 1, characterized in that the drive (1) comprises a pivoting bearing (18) in which that end of the hinge spindle (4) which faces the drive (1) can be mounted pivotably.

7. The drive as claimed in claim 1, characterized in that the drive (1) comprises an angle transmitter (19) which can be connected in a rotationally fixed manner to the hinge spindle (4).

8. The drive as claimed in claim 6, characterized in that the drive (1) comprises a housing (17) to which one of the pivoting bearing (18) and the angle transmitter (19) is fastened via fastening parts.

9. The drive as claimed in claim 8, characterized in that a mount (20) for a rod-shaped supporting element (21) fastened to a hinge (5) is provided on the housing (17).

10. The drive as claimed in claim 3, characterized in that the coupling bars (13, 14) are fastened to the driving lever (10) and to the driven lever (12) via pivoting bearings (15, 16).

11. The drive as claimed in claim 7, characterized in that the drive (1) comprises a housing (17) to which the pivoting bearing (18) and/or the angle transmitter (19) is/are fastened via fastening parts.
